(19) United States
(12) Patent Application Publication
(10) Pub. No.: US 2017/0011651 A1
(43) Pub. Date: Jan. 12, 2017

(54) FLOWERS FORWARD

(71) Applicants: Elizabeth Allison Cave, Salisbury, NC (US); Jake Preston Evans, Charlotte, NC (US)

(72) Inventors: Elizabeth Allison Cave, Salisbury, NC (US); Jake Preston Evans, Charlotte, NC (US)

(21) Appl. No.: 14/796,012

(22) Filed: Jul. 10, 2015

(51) Int. Cl. G09B 19/00

(52) U.S. Cl. CPC G09B 19/0015

(57) ABSTRACT

Flowers forward is a ballet and dance teaching system comprising physical elements that are worn on the body in a variety of forms including appliques on shoes, printed garments and instructions that improve the ability of instructors to teach and students to learn. Flowers forward is implemented in an instructional setting, but can also be used as a game.

This application claims the benefit of provisional patent application 61/998,852 filed on Jul. 10, 2014.

### BACKGROUND

Ballet is a combination of positions and movements that are very technical. For example, turn-out is one of 5 basic positions for the feet that can be taught to new dancers. Another example, croise' derriere is a more technical, overall body (arms, legs, feet) position that can be difficult for experienced dancers to learn and execute precisely. Ballet provides an excellent point of entry for children into the art of dance. Historically, ballet technique is taught verbally and through physical demonstration on behalf of the instructor, in repetition, over a span of years. The art and the exercise are beneficial to children in so many ways.

Communicating the required positions and movements can be especially difficult with children, those with diminished hearing ability or diminished learning capacity

Furthermore, verbal transmission and physical demonstration alone imply a subjective training method that varies according to the instructor and does not provide an objective measurement tool by which to assess one's technique. A new method using visual learning guides will simplify the understanding of complex physical concepts in ballet

Prior art solutions to foot position during dance are specific to other forms of dance such as the “twist”.

Recent prior art solutions to this need tend to utilize electronics with sensors and transmitters. Ballet is a very technical performance art form that does not adapt well to such solutions. Immediate feedback is key. Dance requires knowledge, coordination and ability. Children of a certain age, for all of their imagination, are easily overwhelmed by complexity and respond well to precise cues that are elegant in their simplicity.

Prior art solutions are included in the IDS with specific references as a part of this application.

What is needed is a better, visible, tangible guidance tool and method of teaching. This solution would need a system of tools and methods for its implementation, such that all of the positions of the feet and body could be taught and understood better by those of limited capacities. This solution would especially benefit children, persons with learning limitations, and persons with handicaps that do not lend themselves to traditional dance teaching methods—and may tend to lack the understanding of the more technological solutions. This solution could open the world of ballet to many unreached patrons, and reveal new therapeutic possibilities.

### SUMMARY OF THE INVENTION

“It all began with an idea I had while teaching first position to a ballet class for 5-year-olds. I'm very keen on using images in my teaching and Flowers Forward began as an image. Seeing my students struggle to keep their heels together and turn their feet outward, I told them to imagine they had flowers on the inner side of their heels that needed to be seen by the audience (or in the mirror). I thought this idea would help to demystify the awkward posture of turn-out. The image itself, however, didn't work for them. It was too abstract and the idea of Flowers Forward was born.” Cave, et al.

Flowers forward is a ballet and dance teaching system comprising physical elements that are worn on the body in a variety of forms including appliques on garments, printed garments and instructions that improve the ability of instructors to teach and students to learn. Flowers forward is implemented in an instructional setting, but can also be used as a game.

### DETAILED DESCRIPTION

In this specification, the word embodiment refers to enabled versions of the invention herein described. Embodiments are nonlimiting, and do not define the limits of the disclosed devices, methods and systems. Descriptions of embodiments herein may not specifically refer to modifications obvious to those of ordinary skill in the art, but this does not exclude from this specification any modifications to embodiments that are obvious to those of ordinary skill in the art.

In this specification, “appliques and images” is the expression used to collectively disclose the key features of the present invention. In an embodiment, an applique is a part of the garment. An applique can be a patch. An applique can be sewn directly into the garment. An applique can be otherwise attached to the garment. An applique can be a fabric material, a polymeric material, or another reasonable material that is visible, somewhat resilient, and can be attached to hold an appliques position and orientation. An applique can be molded, sown or otherwise formed as an integral part of the garment during manufacture.

In this specification, “images” refers to a visible element that is more integrated to the garment or the applique. In an embodiment, an image is a part of the garment. An image can be part of a patch. An image can be ironed on. An image can be sewn as an integral part of the garment, such as with colored thread used during manufacture. An image can be otherwise attached to the garment. An image can be a fabric material, a polymeric material, or another reasonable material that is visible, somewhat resilient, and can be attached to hold an images position and orientation. An image can be molded, sown or otherwise formed as an integral part of the garment during manufacture.

In this specification, the term “seen” refers to visual action by the dancer, instructor, mirror reflection or other image capture device (such as a camera) or person.

In an embodiment, at least one image is part of at least one applique. In an embodiment, applique and image includes a temporary tattoo or a sticker.

Physical elements such as appliques and images are worn and used by the student to define specific positions for various parts of the body. In an embodiment, the present invention is implemented using embroidered appliques and images that are secured to the shoes in specific locations. The appliques and images are generally flat, and have visible details that can only be seen from one direction.

The appliques and images are placed so that the line of sight from a dancer to a mirror and then to the appliques and image is that one direction. Specifically, to define and teach the foot position for ballet position 1 (heels together and feet pointed opposite one another, outward and to the side) there would be an applique positioned outside the shoe, at the inside of the heels on each foot. This applique being similar to a coin on which an image is visible only when seen from a particular direction. Only when the feet are in position can the dancer sees the full image.

In an embodiment, appliques and images include at least one line, circle, or other geometric shape having intrinsic alignment properties to assist with aligning the dancer's body.

In an embodiment, the appliques and images are embroidered attachments having raised and unraised portions, such that the image seen by the user when the attachment is in position is different from the image seen when out of position. This embodiment is useful to teach an advanced student to perfect the positioning beyond a basic understanding.

In an embodiment, the raised and unraised portions of the appliques and images are spaced according to the level of precision required of the dancer. For example, wider spacing allows for a less precise positioning. Narrower spacing, in turn, provides for precise positioning. Technically, using a foot placement example, the wider raised and unraised spacing (for example, 5 mm) would allow visibility of the unraised portion for a 10 degree range of foot positions from a full 360 degree range (perhaps 90 degree range of foot mobility). This is an appropriate range for a child beginning the course. However, a narrower spacing (for example 2 mm) would allow visibility of the unraised portion for a 2 degree range of foot positions. This latter example is appropriate for a more advanced student. This example can be implemented using a selection matrix that defines a user's ability to execute a dance position and movement, which corresponds to the level of detail in an applique or image on a garment.

In an embodiment, multiple images are attached to define a bodily position. As an example, three images are on a foot. One image is on the front, and it serves as the positive image that is to be seen. Two images, one on either side of the shoe are the negative images that are to be hidden from view when the foot is in position. As another example, this is a solution to teach the student about “rolling in” also known as pronation, described as when the big toe is rolled over and allowing the pinky toe to come off of the floor, a common habit among ballet beginners. For example, the positive image on the side is encouraged to be seen and the negative images above and below are encouraged to be hidden. This also exemplifies that the appliques and images can be very small, or narrow to allow greater precision of body position.

In an embodiment, each of the eight general body positions for ballet are demonstrated by the present disclosure. These positions include at least one of the head, torso, shoulders, arms, legs, feet, posture and facial expression.

In an embodiment, each of the five basic foot positions are demonstrated by the present invention. For position 1, appliques and images are at the inside of each heel, visible from the front when the inside of the heels are positioned directly forward.

In an embodiment, the position of the appliques and images are unique to the student's ability. As an example, for those with increased flexibility, an indicator such as “level” or “stage” or a certain color would identify the product as being for those with increased flexibility.

In an embodiment, there are appliques attached to the body and the appliques have a reflective surface integrated. The mirrored applique interacts with lighting in front of mirrors. The lighting is from an infrared source or other generally directional lighting that is pointed outward from a wall, parallel to the floor, and at a height that is appropriate to the desired body position. The mirrors, when properly positioned will reflect the light in a way that is visible to the dancer and other persons in the room.

In an embodiment, the appliques are gender specific, interest specific, or otherwise customized to capture the focus of the student. As a nonlimiting example, boys will be more inspired by a Batman set of appliques and images than flowers.

In an embodiment, a garment such as tights are worn on the legs with appliques and images specifically placed to provide visual guides to assist in the proper placement and alignment of the legs. Similarly, such an embodiment is used on the arms, wrists, and hands as a visual guide.

In an embodiment, tights or garment worn on legs with an accessory or mechanism that provides a visual and/or sensory guide to assist in the proper engagement of the knee/kneecap/leg. The sensory guide is at least one of audible, tactile, scent, visual, or other indicator that can be used by a dancer and instructor.

In an embodiment, a leotard or other garment worn on upper body has appliques and images as markers that provide visual guides to assist in the proper placement and alignment of the torso. This includes posture.

In an embodiment, a hair piece or other hair accessory is worn on head to provide a visual guide to assist in the proper placement, alignment, and use of the head.

In an embodiment, a game is played. Multiple body positions are marked with appliques and images, each corresponding to ballet positions. As an example, corresponding body positions have a particular color assigned to them from a multiple color spectrum. As an example, the red appliques correspond to foot position 1, and are placed on either foot. As an example, ballet body positions also have a particular color assigned to them from a multiple color spectrum. The ballet positions can be arm, torso, leg, foot, hand and any other body positions that are definitive of the ballet position. A caller can be used to announce and keep score in the game. Multiple simultaneous players are possible. Upon announcing a body position, a game player will move their body to the appropriate position and receive points for successfully completing the movement. At the end of the game, the player with the most points wins. The body positions appear on game cards with their color, name and history. The caller may choose either of these to announce the body position. Scoring can be indicated on the card according to the difficult of the question.

### SUMMARY OF THE DRAWINGS

FIG. 1 demonstrates the Plie position showing appliques and images that help the dancer define their proper position.

FIG. 2 demonstrates the 8 basic ballet body positions for a dancer. FIG. 3 demonstrates a ballet shoe showing 8 locations for appliques and images.

FIG. 4 demonstrates a dancer's ballet position showing locations for body position line appliques and images.

FIG. 5 demonstrates an exemplary embodiment of appliques and images having at least one raised and one lowered section.

FIG. 6 demonstrates an exemplary embodiment of appliques and images having a mirrored surface interacting with a light source and the user.

### DETAILED DESCRIPTION OF THE DRAWINGS

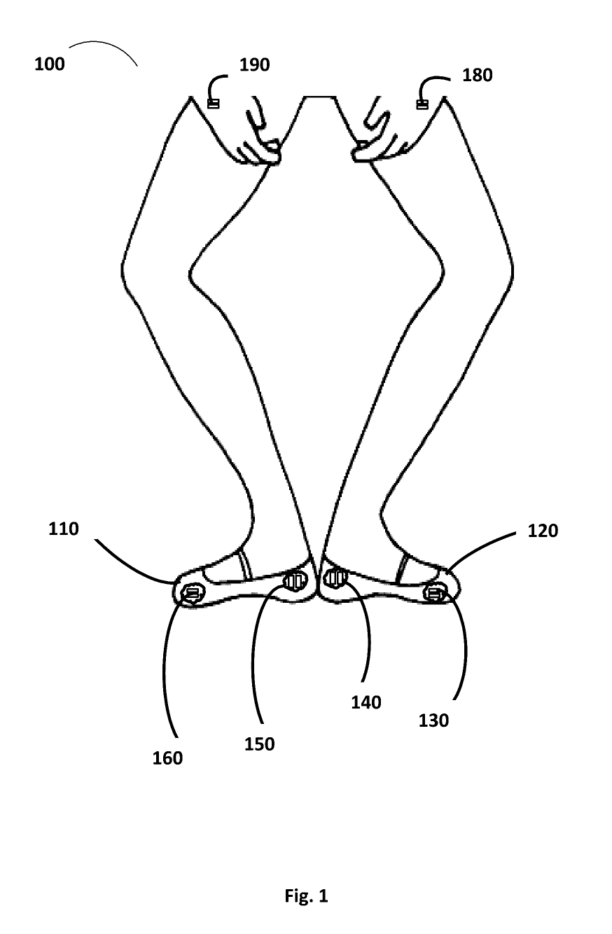

FIG. 1 demonstrates an embodiment of the disclosed invention. Plie position as shown, can be seen from the front of the dancer as the two feet pointed opposite each other. 100 demonstrates a dancer with a right shoe 110 and a left shoe 120. Applique and image 130 is at the forward part, inside the foot, and outside of the left shoe. Similarly, 140 is at the rearward part. 150 and 160 demonstrate the right shoe appliques and images. 180 and 190 demonstrate locations for additional appliques and images, shown as stickers.

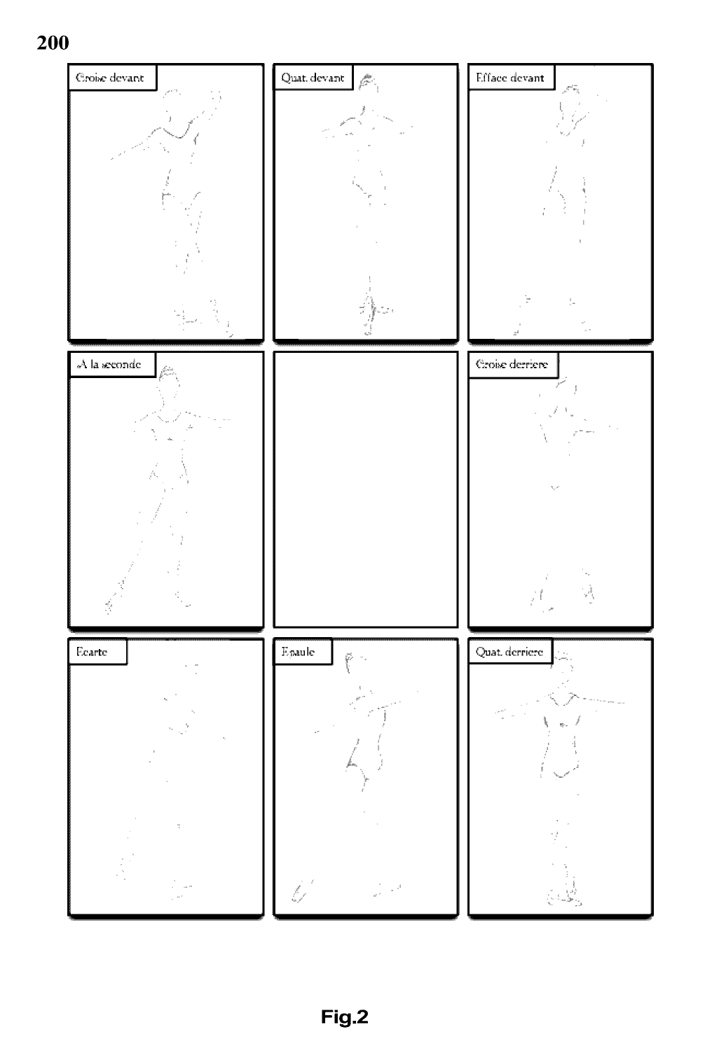

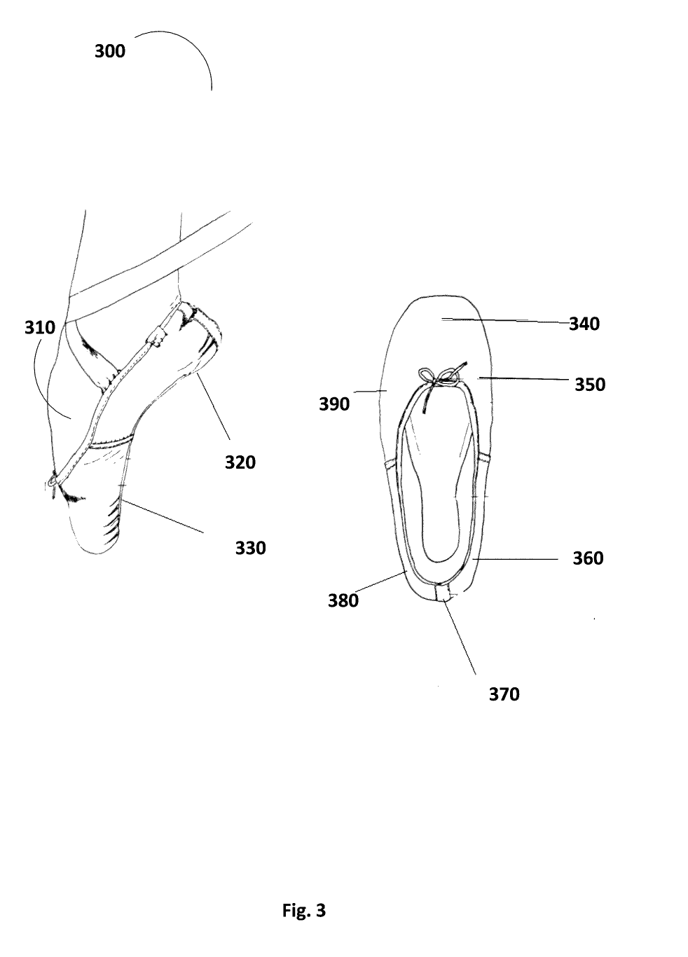

FIG. 2 demonstrates eight positions of the body from which all the various steps are executed.

1. Croisé Devant

2. Quatrième Devant

3. Effacé Devant

4. à la Seconde

5. Croisé Derriere

6. Ecarté

7. Epaulé

8. Quatrième Derrière

In this specification, the following French vocabulary helps to understand embodiments of the present invention. The dancer creates positions mixing the different components.

Devant: To the front

Derrière: To the back (close to the rear)

Croisé: Crossed alignment

Seconde: To the second position (lateral)

Èarté: Separated or thrown wide apart

Effaće: Shaded

Epaulé: Shouldered (so when people talk about épaulement, they really are referring to the position of the upper body starting from the shoulders and the upper back)

In an embodiment, the Croisé Devant position is demonstrated by the present invention. By definition, this is Crossed alignment, to the front. Standing at an oblique angle away from the audience, extend the leg nearest the audience into the fourth position, pointing on tendu, stretched to the front. The arms are placed in (open) fourth position, such that the lower arm is on the same side as the extended leg. Appliques and images would be present on the legs, arms and feet in a manner that they would be visible to the dancer and to the instructor.

In an embodiment, the Quatrième Devant position is demonstrated by the present invention. Facing the audience, the working leg is extended to fourth position, pointing on tendu to the front, with the arms in second position (open) and the head facing the audience. Appliques and images would be present on the legs, arms and feet in a manner that they would be visible to the dancer and to the instructor.

In an embodiment, the Effacé Devant position is demonstrated by the present invention. Standing at an oblique angle to the audience (facing a corner), such as that part of the body is hidden. The leg further from the audience becomes the working leg and is extended in fourth position, pointing on tendu to the front. The arms are placed in (open) fourth position such that the lower arm is on the same side as the extended leg. Appliques and images would be present on the legs, arms and feet in a manner that they would be visible to the dancer and to the instructor.

In an embodiment, the à la Seconde position is demonstrated by the present invention. Facing the audience, the working leg is extended to second position, pointing on tendu to the side, with the arms in second position (open) and the head facing the audience. It is also referred as à la seconde en face. Appliques and images would be present on the legs, arms and feet in a manner that they would be visible to the dancer and to the instructor.

In an embodiment, the Croisé Derriere position is demonstrated by the present invention. Standing at an oblique angle to the audience (facing a corner). The leg further from the audience becomes the working leg and is extended in fourth position, pointing on tendu to the back. The arms are placed in (open) fourth position such that the lower arm is on the same side as the extended leg. Appliques and images would be present on the legs, arms and feet in a manner that they would be visible to the dancer and to the instructor.

In an embodiment, the Ecarté position is demonstrated by the present invention. Facing any corner, the leg nearer to the audience becomes the working leg and is extended in second position, pointing on tendu to the side. The arms are in (open) fourth position so the highest arm is on the same side as the extended leg. The head is raised slightly and turned toward the raised arm, so the eyes look into the hand. Appliques and images would be present on the legs, arms and feet in a manner that they would be visible to the dancer and to the instructor.

In an embodiment, the Epaulé position is demonstrated by the present invention. Standing at an oblique angle to the audience, the dancer stands in arabesque facing one of the corners (the working leg is the one closest to the audience and is extended to the back in fourth position). The arm closest to the audience is extended forward, and the head is inclined and turned towards the audience. Appliques and images would be present on the legs, arms and feet in a manner that they would be visible to the dancer and to the instructor.

In an embodiment, the Quatrième Derrière position is demonstrated by the present invention. Facing the audience, the working leg is extended to fourth position, pointing on tendu to the back, with the arms in second position (open) and the head facing the audience. Appliques and images would be present on the legs, arms and feet in a manner that they would be visible to the dancer and to the instructor.

FIG. 3 demonstrates a ballet shoe to show an embodiment of locations for appliques and images. 310 demonstrates a location on the top of the foot, this can be a line to provide additional placement information to the instructor and dancer. 320 demonstrates a location under the shoe at the heel. 330 demonstrates a location under the shoe at the toe or ball of the feet. 340 demonstrates a location at the top of the shoe and at the front. 350 demonstrates a location on the shoe, at the side and forward. 360 demonstrates a location on the shoe, rearward and on the side. 370 demonstrates a location on the shoe, at the rear of the shoe. 380 demonstrates a location on the shoe, rearward and on the outer side of the shoe. 390 demonstrates a location on the shoe, forward and on the outer side.

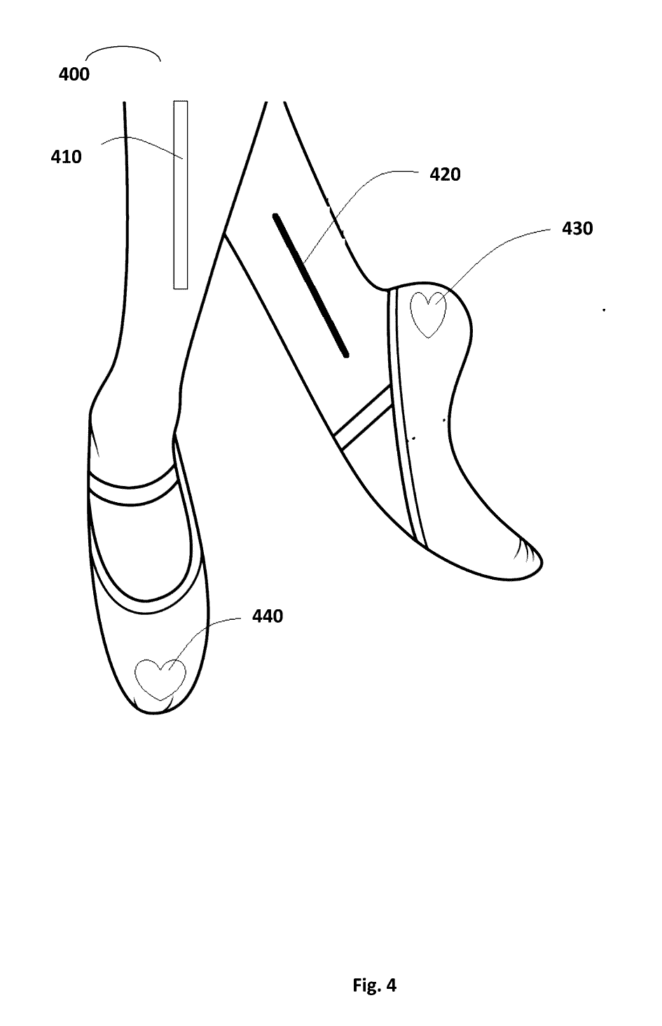

FIG. 4 demonstrates the lower legs and feet of a dancer, in a ballet position. 410 shows a line that communicates to the dancer and the instructor that the leg is directed forward and vertically aligned. 420 shows that the rear or left leg is properly rotated and at a proper angle, with the top of the line pointing to the top of the other. 430 demonstrates a heart shaped applique or image at the rear of the shoe, inside. 430 shows that the rear or right foot is properly rotated and uprightly vertically aligned. 440 shows a heart shaped applique located on top and forward on the shoe. 440 shows that the front or right foot is properly lifted, oriented and positioned.

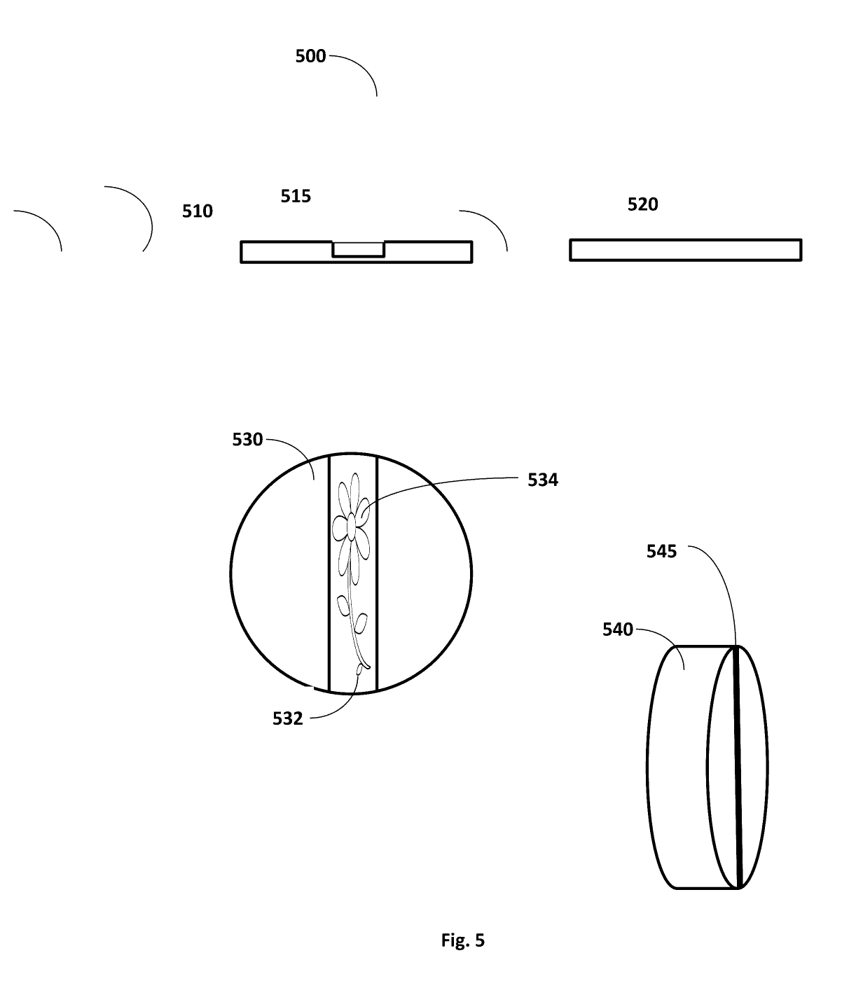

FIG. 5 demonstrates an exemplary embodiment of appliques and images having at least one raised and one lowered section. Drawing 500 shows an applique 510 with a lowered section 515. 520 shows a side view of the applique. 530 shows a plan view of the applique. 532 shows the plan view of the lowered section. 534 shows an image of a flower in the bottom of the lowered section. 540 shows a partial isometric view of the applique, having the lowered section 545 no longer in a direct line of sight. Thus also showing that the image 534 is hidden.

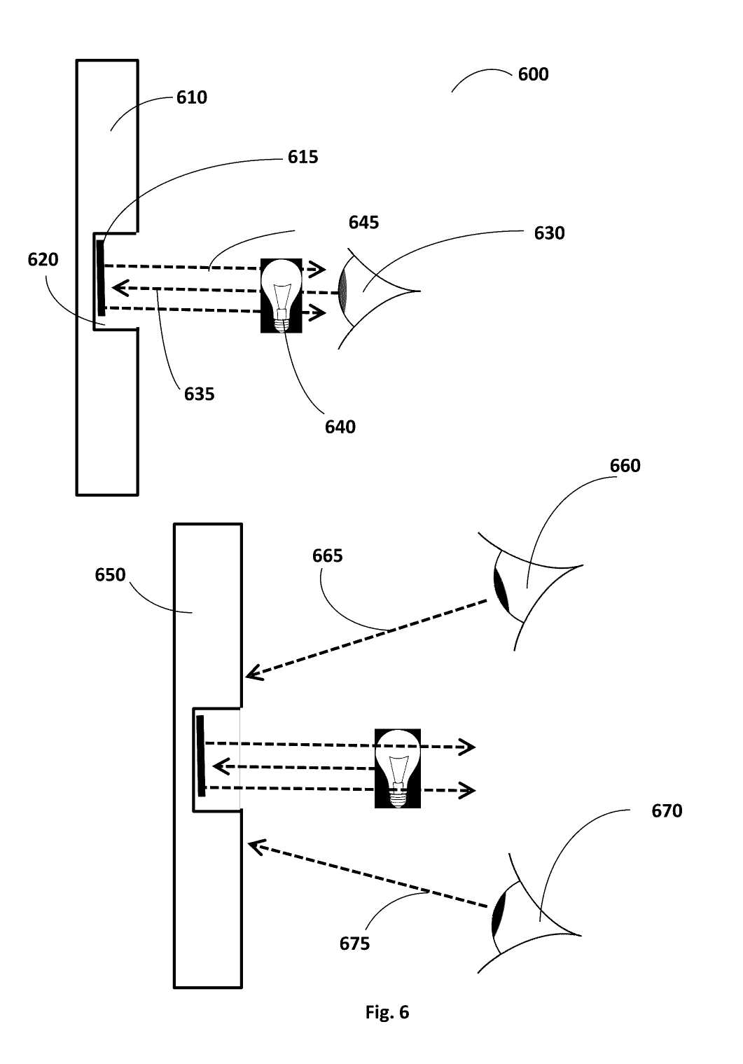

FIG. 6 demonstrates an exemplary embodiment of appliques and images having a mirrored surface interacting with a light source and the user. Drawing 600 shows applique 610, having lowered section 620 with a mirrored surface 615 secured in the lowered section 620. Light source 640 having two dotted lines showing descriptive linear path of light coming from the source and reflecting linearly off of the mirrored surface. 630, the eye represents the user's eye and representative linear line of sight 635. In this upper image, the components work together so that the reflection of the light source is visible to the eye. Thus indicating a particular alignment of the applique, and thus representing the proper placement of the body part to which the applique is attached.

In contrast, the lower image demonstrates an applique 650 not aligned with the two eyes 660 or 670, and the lines of sight 665 and 675 not being aligned with the light source as shown. As a result, this applique is not in a particular position. Thus the body part to which the applique is attached is not aligned. And, the reflection of the light source is not visible.

I claim:

1. A system of nonmagnetic appliques and images placed on garments and used by a dancer, said system indicating the proper position for the user to place, align, hold, and move each particular body part to accomplish precise dance positions and movements;
the system further having such appliques and images visible to the user when each particular body part is held in the precise dance position and movement;
And the images being visible to the user as the user executes a dance position and movement.

2. The system of claim 1 wherein an instructor can see the appliques and images and uses this information to assist the dancer in executing a dance position and movement.

3. The system of claim 1 wherein the appliques and images are visible features that hold their position relative to the body and are made using any combination of the group of fabric patches, polymeric patches, attached directly to the garment, molded, sown or otherwise formed as an integral part of the garment during manufacture.

4. The system of claim 1 where in the appliques and images are generally flat, and have visible details that can only be seen from one direction.

5. The system of claim 1 wherein the appliques and images are formed of a polymer, or embroidered attachments having raised and upraised portions, such that the image seen by the user when the attachment is in position is different from the image seen when out of position.

6. The system of claim 1 wherein the appliques and images are formed of a polymer, or embroidered attachments having raised and unraised portions, such that the image seen by the user when the attachment is in position is different from the image seen when out of position and the distance of the spacing and the difference in height between the raised and unraised portions are calibrated according to a level of ability, flexibility and precision of body position.

7. The system of claim 1 wherein multiple appliques and images are worn to define a bodily position, wherein at least one is a positive applique or image that is desired to be Seen when in proper position and at least one is a negative applique or image that is desired to not be seen when in proper position.

8. The system of claim 1 wherein ballet foot positions corresponding to the 8 body position Quatrieme Devant, Efface Devant, Seconde, Derrière, Croisé, Ècarté, Epaulé and Quatrième Derrière are demonstrated by the placement of appliques and images on at least one garment.

9. The system of claim 1 wherein each of the eight general ballet body positions 8 body positions Quatrieme Devant, Efface Devant, Seconde, Derrière, Croisé, Ècarté, Epaulé and Quatrième Derrière are demonstrated by the placement of appliques and images on at least one garment.

10. The system of claim 1 wherein the position of the appliques and images correlate to a selection matrix that presents specific foot position deviations that vary according to a user's ability to execute the dance position and movement.

11. The system of claim 1 where in the appliques and images have an integrated reflective surface, said reflective surface interacting with lighting coming from the direction of a wall, and said surfaces reflecting the light onto a wall having markings to indicate proper positions or said surfaces reflecting the light into another mirrored surface visible to the user.

12. The system of claim 1 wherein the appliques are gender specific to boys or girls, and interest specific such as super heroes, flowers, and customized to capture the focus of particular students.

13. The system of claim 1 wherein a garment includes shoes, socks, tights, shirts, hats, hair accessories, gloves, rings, leg coverings, torso coverings, arm coverings and head coverings having specifically placed appliques and images to provide visual guides to assist in the proper placement and alignment of the body.

14. The system of claim 1 wherein appliques and images include nonmagnetic removable features that are clips, Velcro appliques, adhesive appliques, temporary tattoo or stickers.

15. The system of claim 1 having appliques and images on garments and further having playing cards with graphics that match the appliques and images on one side of the cards, and the other side of the cards include the name of foot and body positions, a demonstration of foot and body positions, and a historic statement about the body and foot positions; and further including a gaming die.
